(19) United States
(12) Patent Application Publication
(10) Pub. No.: US 2007/0285394 A1
(43) Pub. Date: Dec. 13, 2007

(54) KVM SWITCH SYSTEM CAPABLE OF TRANSMITTING KEYBOARD-MOUSE DATA AND RECEIVING VIDEO DATA THROUGH SINGLE CABLE

(75) Inventors: Chieh-kwei Lee, Shijr City (TW); Chien-wen Yu, Shijr City (TW)

Correspondence Address: MADSON & AUSTIN, 15 WEST SOUTH TEMPLE, SUITE 900, SALT LAKE CITY, UT, 84101, US

(73) Assignee: Aten International Co., Ltd., Shijr City (JP)

(21) Appl. No.: 11/423,018

(22) Filed: Jun. 8, 2006

(51) Int. Cl. G09G 5/00

(52) U.S. Cl. 345/168

(57) ABSTRACT

A KVM switch system capable of communicating with a selected computer through a single cable is disclosed. Between the computer and the KVM switch system, keyboard/mouse data is transmitted and video data is received through a single cable. The KVM switch system includes a protocol controller, a graphic controller, a switch and a plurality of transceivers. The KVM switch system is coupled to plural computers. The protocol controller transforms keyboard/mouse signals into the keyboard/mouse data in a protocol standard and transforms the video data in the same protocol standard into video signals. The graphic controller receives the video signals from the protocol controller and transmits the video signals to a display. The switch routes the keyboard/mouse data and the video data according to a processor of the KVM switch system. The transceivers, each coupling the switch to each of plural computers with one single cable respectively, transmits the keyboard/mouse data to the selected computer and receives the video data from the selected computer over single protocol standard through the single cable.

### FIELD OF THE INVENTION

The present invention generally relates to a keyboard-video-mouse switch system and more particularly to a keyboard-video-mouse switch capable of transmitting keyboard/mouse data and receiving video data to/from a computer through a single cable.

### BACKGROUND OF THE INVENTION

A keyboard-video-mouse (KVM) switch has been developed as an important solution of multi-users, remote access and management for a network interconnecting a large amount of console devices and a large amount of computers thereto. Traditionally, the keyboard, video, mouse data are transmitted and received between the KVM switch and the computers by respective cables. Also, these cables connect the computers and the keyboard-video-mouse switch through respective terminals, i.e. the video connectors (commonly, D-sub 15 pins VGA connectors), the mouse connectors and the keyboard connectors (commonly, PS/2 or USB connectors). Once the number of the computers connected to the keyboard-video-mouse switch is increased more and more, these sets of keyboard-video-mouse cables correspondingly occupy a lot of space between the keyboard-video-mouse switch and the connected computers. Especially, the occupation space of many cables grows up for a racked, clustered computers or servers due to the less space for the setup of these computers. Meanwhile, the large amount of cables required by the number of the connected computers dose not only occupy a lots of space but also cause the bad radiation of the KVM switch, the computers and the cables themselves.

Please refer to FIG. 1, which illustrates a simple block diagram of a traditional keyboard-video-mouse switch, transmitting the keyboard/mouse data and receiving the video data to/from the computer 208 and 210 with respective cables. The keyboard-video-mouse switch is connected with a keyboard 202 and a mouse 204. Meanwhile, a display 206 is coupled to the keyboard-video-mouse switch for receiving the video signals to show operation information for users. For example in a big rack, clustered computers are setup to be connected to a keyboard-video-mouse switch device for being remote accessed. Three cables are necessary for coupling each computer to a keyboard-video-mouse switch. If twenty computers are setup, there will be sixty cables crowed in the whole rack. As we know well, the enough space is the key for radiation of the electronic equipments like switch, etc mentioned above. Continuously being driven in a higher temperature working room will definitely cause the shortening to the lifetime of the equipment. Consequentially, there is a need to decrease the occupation space of the cables. Meanwhile, decreasing the number of the cables also makes the setup of the computers with the keyboard-video-mouse switch easier. For example, if transceiving the keyboard-video-mouse data over single protocol standard through one single cable is a considerable solution.

Furthermore, the size of the keyboard-video-mouse switch can be diminished with such idea because the number of circuitry devices inside for transceiving the keyboard-video-mouse data over single protocol standard through one single cables must less than the one for traditional designs. For instance, one set of switch devices including three selecting circuit devices for outputting/inputting keyboard, video and mouse data respectively can be replaced by one single selecting circuit devices because keyboard-video-mouse data are transmitted over single protocol standard in one single cable. Therefore, the occupation space of the keyboard-video-mouse switch also can be minified.

Consequentially, there is a need to develop a keyboard-video-mouse switch capable of transmitting keyboard/mouse data and receiving video data to/from a computer over single protocol standard and through a single cable.

### SUMMARY OF THE INVENTION

To solve the foregoing drawbacks in the prior art, it is an objective of the present invention to provide a keyboard-video-mouse switch system capable of transmitting keyboard/mouse data and receiving video data to/from each of plural computers through a single cable.

The present invention provides a keyboard-video-mouse switch system for transmitting keyboard/mouse data and receiving video data through a single cable. The KVM switch system includes a processor, a protocol controller, a graphic controller, a switch and a plurality of transceivers. The processor controls the keyboard-video-mouse switch system to select one of the plural computers for transmitting keyboard/mouse data thereto and receiving video data therefrom. The protocol controller transforms keyboard/mouse signals into the keyboard/mouse data in a protocol standard and transforms the video data in the same protocol standard into video signals. The graphic controller receives the video signals from the protocol controller and transmits the video signals to a display. The switch, coupled to the protocol controller switches to route the keyboard/mouse data in the protocol standard and the video data in the same protocol standard according to the processor. The transceivers, each coupling the switch to each of plural computers with one single cable respectively, transmits the keyboard/mouse data to the selected computer and receives the video data from the selected computer over single protocol standard through the single cable. The keyboard-video-mouse switch system also includes a graphic interface between the graphic controller and the display. The keyboard-video-mouse switch system further includes a keyboard/mouse controller and a buffer. The keyboard/mouse controller transmits the keyboard/mouse signals from the keyboard/mouse devices to the protocol controller. The buffer, coupled to the graphic controller and the protocol controller respectively for saving the video signals from the protocol controller temporarily for buffering large transmission loading of the video signals to the graphic controller. Furthermore, whether the buffer saves the video signals is determined by a command from the processor when it is necessary. Specifically, the aforesaid protocol can be a Universal Serial Bus protocol; accordingly, the protocol controller can be a Universal Serial Bus protocol controller.

The method for transmitting keyboard/mouse data and receiving video data to/from a selected computer over single protocol standard through a single cable according to the present invention includes the steps of:

transforming the keyboard/mouse signals into keyboard/mouse data in a protocol standard;

switching to route the keyboard/mouse data and the video data in the protocol standard;

transmitting the keyboard/mouse data and receiving the video data in the protocol standard to/from the selected computer through the single cable; and

transforming the video data in the protocol standard into video signals.

Thereafter, the video signals are transmitted to a display.

The method according to the present invention further includes steps of:

determining whether the video signals are saved before the saving step; and

saving the video signals temporarily for buffering large transmission loading of the video signals before the step of transmitting the video signals to the display.

According to the keyboard-video-mouse switch system of the present invention, transmitting keyboard/mouse data and receiving video data to/from a selected computer over single protocol standard through a single cable can be achieved. Meanwhile, the present invention decreases the number of the cables between the computers and the keyboard-video-mouse switch easier. Correspondingly, the occupation space of the cables can be minified. The size of the keyboard-video-mouse switch also can be diminished.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 illustrates a simple block diagram of a traditional keyboard-video-mouse switch transmitting the keyboard/mouse data and receiving the video data to/from the computer with respective cables;

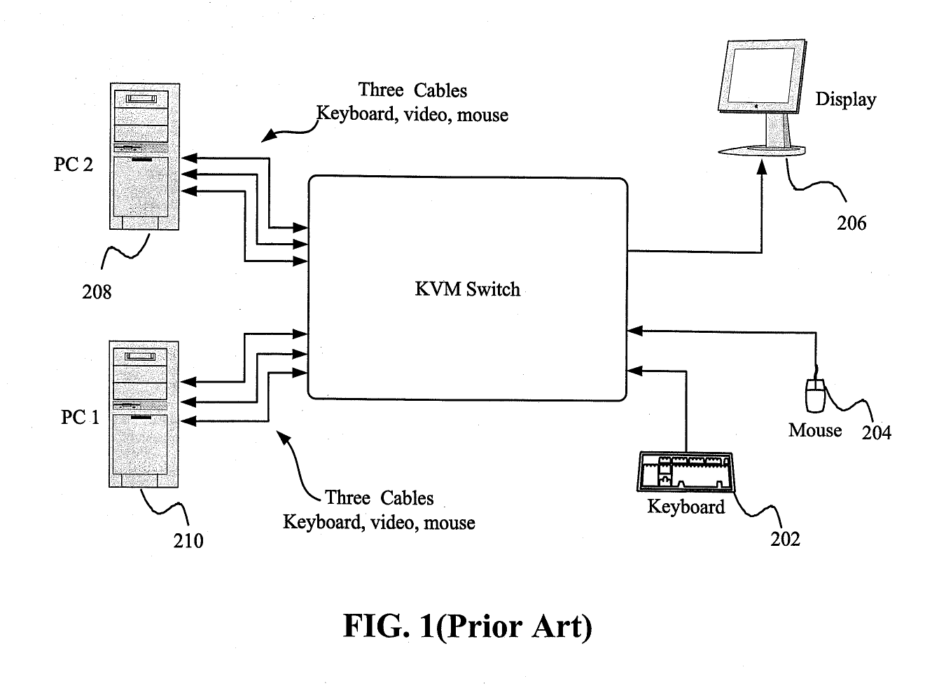

FIG. 2 illustrates a simple block diagram of a keyboard-video-mouse switch transmitting the keyboard/mouse data and receiving the video data to/from the computer over single protocol standard through a single cable according to the present invention;

FIG. 3 illustrates a detail block diagram of a keyboard-video-mouse switch for transmitting the keyboard/mouse data and receiving the video data to/from the computer; and

FIG. 4 shows a flow chart of the method for transmitting the keyboard/mouse data and receiving the video data to/from the computer over single protocol standard through a single cable.

### DETAILED DESCRIPTION OF THE PREFERRED EMBODIMENTS

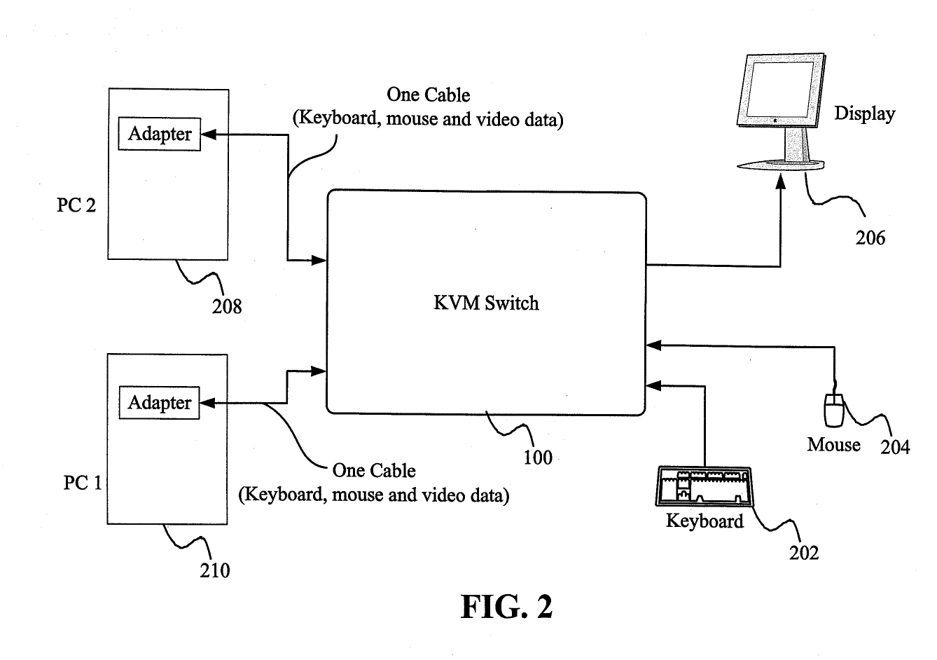

Please refer to FIG. 2, which illustrates a simple block diagram of a keyboard-video-mouse (KVM) switch of the present invention. The switch of the present invention is coupled with a keyboard 202, a mouse 204 and a display 206 as a console for user's operation. The keyboard-video-mouse (KVM) switch 100 according to the present invention is capable of transmitting the keyboard/mouse data and receiving the video data to/from the computer over single protocol standard through a single cable, such as a USB cable. Therefore, decreasing the number of the cables occupying space thereof to create enough space for better radiation of the electronic equipments around is achieved. Meanwhile, the occupation space of the keyboard-video-mouse switch also can be minified correspondingly. The computer in the embodiment of the present invention includes a USB adapter or converter capable of outputting the video data in a USB format via a USB port of the computer. The adapter can be realized in software installed in the operation system of the computer or a hardware adapter directly transforms the video data into a USB format, such as VGA format to USB format, or differential format to USB format.

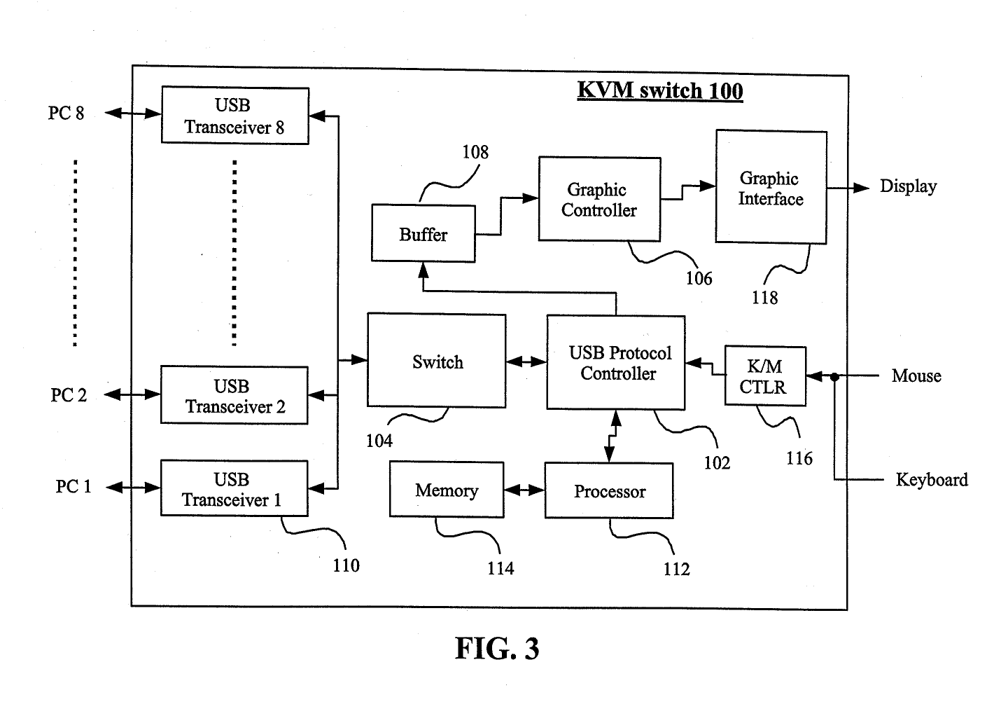

Please refer to FIG. 3. It illustrates a detail block diagram of a keyboard-video-mouse switch capable of transmitting keyboard/mouse data and receiving video data to/from a computer over single protocol standard through a single cable, which is a USB cable in this embodiment. The keyboard-video-mouse switch 100 includes an USB protocol controller 102, a switch 104, a graphic controller 106, a buffer 108, eight USB transceivers (the USB transceiver 1 is represented by numbered 110), a processor 112, a memory 114, a keyboard/mouse controller 116 (K/M CTRL) and a graphic interface 118. Significantly, the numbers of the USB transceivers are not specified as eight as in this embodiment, it depends on the capability to connect computers (PC) of the KVM switch 100. Meanwhile, more detail description about how to implement the USB transceiver can be referred to U.S. Pat. No. 5,781,028. The USB transceiver 110 can be a Max3346E device manufactured by Dallas Semiconductor.

The USB protocol controller 102 transforms the keyboard signals, the mouse signals or both into keyboard signals, the mouse data or both in USB standard and transforms the video data in the USB standard into video signals. The keyboard signals and the mouse signals do not necessarily coexist but their homogeneity property hereby are written together. The switch 104 routes the keyboard-mouse data and video data in the USB standard to/from a selected computer. The USB transceiver 1 (110) coupled to the switch 104 and the computer (PC1) with a single cable is to transmit the keyboard/mouse data and receive the video data to and from the computer (PC1). The graphic controller 106 receives the video signals from the USB protocol controller 102 through a buffer 108, which is coupled to the graphic controller 106 and the USB protocol controller 102 respectively. The graphic controller 106 transmits the video signals to a display via the graphic interface 118. The memory 114 can be a firmware storage device for the processor 112 in the keyboard-video-mouse switch. The keyboard/mouse controller 116 (K/M CTRL) is coupled to the USB protocol controller 102 and a keyboard device, a mouse device to transmit the keyboard/mouse signals from the keyboard device, the mouse device to the USB protocol controller 102.

During the operation of the keyboard, mouse devices by a user to control the one of the computers (The user first selects one of the computers PC1 to PC8), the processor 112 generates a command to the switch 104 according to the user's selection. The keyboard/mouse controller 116 (K/M CTRL) receives the keyboard/mouse signals from the keyboard, mouse device. The USB protocol controller 102 transforms the keyboard/mouse signals into keyboard/mouse data in the USB standard. The USB transceiver 1 transmits the keyboard/mouse data from the USB protocol controller to the selected computer and receives the video data in the USB standard from the selected computer to the USB protocol controller 102 through the single cable. The USB protocol controller 102 transforms the video data in the USB standard into the video signals and transmits the video signals to the graphic controller 106 through a buffer 108. The buffer 108 is for saving the video signals from the USB protocol controller 102 temporarily for buffering the large transmission loading of the video signals. If it is necessary, the processor 112 will send a command for buffering; if it is not, the video signals will be transmitted through the buffer right away. The graphic controller 106 transmits the video signals via a graphic interface to the display. Consequentially, the operation status information, i.e. the video signals from the selected computer will be shown on the display when the user operates the keyboard mouse device. As a result, the keyboard-video-mouse switch capable of transmitting the keyboard/mouse data and receiving the video data to/from the computer over single protocol standard through a single cable is realized. In this embodiment, all the keyboard-video-mouse signals are transformed into the data in the USB standard but the other data protocol standard is also considerable by different KVM switch hardware design.

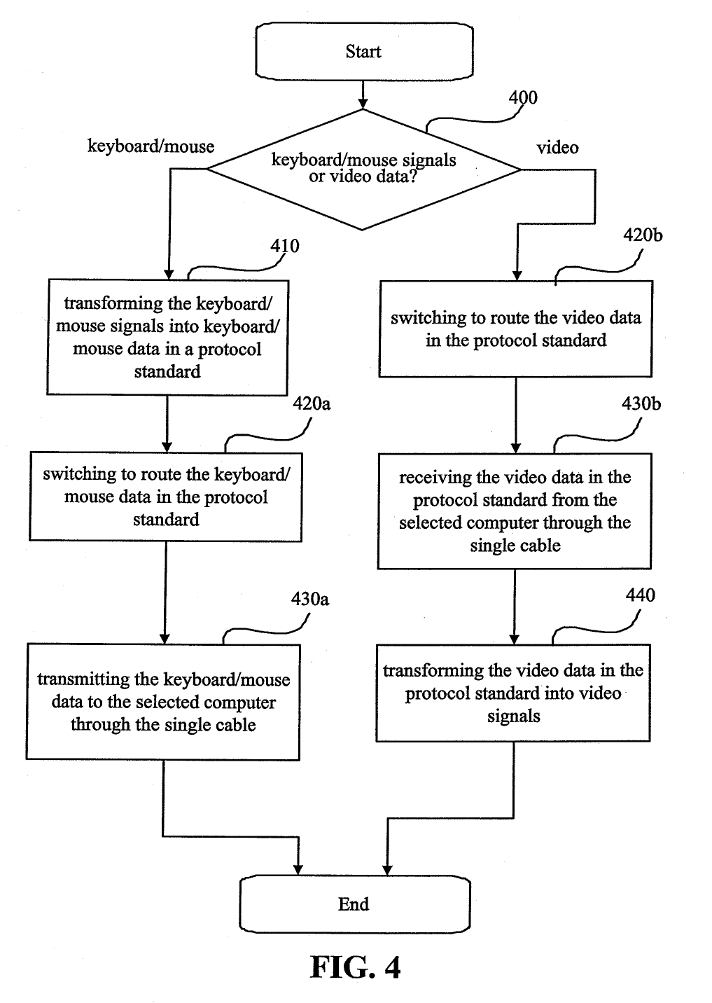

Please refer to FIG. 4, which shows a flow chart expressing the method for transmitting the keyboard/mouse data and receiving the video data to/from the computer over single protocol standard and through a single cable. In step 400, the processor will determine whether the keyboard/mouse signals or the video data are inputted. In case of the keyboard/mouse signals are inputted, the method proceeds to step 410. In step 410, the USB protocol controller according to the present invention transforms the non-USB keyboard/mouse signals, such as PS/2 keyboard/mouse signals, into keyboard/mouse data in USB standard. In step 420a, the switch switches to route the keyboard/mouse data according to the processor. In step 430a, the USB transceiver transmits the keyboard/mouse data in the USB standard to the selected computer through the single cable. In case of the video data are inputted, the method proceeds to step 420b. In step 420b, the switch switches to route the video data in the USB standard according to the processor. In step 430b, the USB transceiver receives the video data in the USB standard from the selected computer through the single cable. In step 440, the USB protocol controller according to the present invention transforms the video data in the USB standard into the non-USB video signals. Accordingly, the video signals are transmitted to the display for showing the operation status for the user. The non-USB video signals are not specified. It depends on the specification of the display or the user's demand. Furthermore, the method may include a step of saving the video signals temporarily before transmitting the video signals to the display for buffering the large transmission loading of the video signals. If it is necessary, the processor will send a command for buffering; if it is not, the video signals will be transmitted through the buffer right away.

Correspondingly, the present invention decreases the number of the cables between the computers and the keyboard-video-mouse switch. The occupation space of the cables can be minified. The size of the keyboard-video-mouse switch also can be diminished.

As is understood by a person skilled in the art, the foregoing preferred embodiments of the present invention are illustrative rather than limiting of the present invention. It is intended that they cover various modifications and similar arrangements be included within the spirit and scope of the appended claims, the scope of which should be accorded the broadest interpretation so as to encompass all such modifications and similar structure.

What is claimed is:

1. A keyboard-video-mouse switch system for transmitting keyboard/mouse data and receiving video data to/from each of plural computers through a single cable, the switch system comprising:
a processor;
a protocol controller, transforming the keyboard/mouse signals into keyboard/mouse data in a protocol standard and transforming the video data in the protocol standard into video signals;
a graphic controller, coupled to the protocol controller, receiving the video signals from the protocol controller and transmitting the video signals to a display;
a switch, coupled to the protocol controller, switching to route the keyboard/mouse data in the protocol standard and the video data in the protocol standard according to the processor; and
a plurality of transceivers, each coupling the switch to each of the plural computers with single cable respectively, for transmitting the keyboard/mouse data and receiving the video data to/from the selected computer through the single cable;

2. The keyboard-video-mouse switch system of claim 1, further comprising a keyboard/mouse controller, coupled to keyboard/mouse devices, transmitting the keyboard/mouse signals from the keyboard/mouse devices to the protocol controller.

3. The keyboard-video-mouse switch system of claim 1, further comprising a buffer, coupled to the graphic controller and the protocol controller respectively for saving the video signals from the protocol controller temporarily for buffering large transmission loading of the video signals to the graphic controller.

4. The keyboard-video-mouse switch system of claim 3, wherein whether the buffer saves the video signals is determined according to the processor.

5. The keyboard-video-mouse switch system of claim 1, wherein the protocol controller is a Universal Serial Bus protocol controller.

6. A method for transmitting keyboard/mouse data and receiving video data to/from a selected computer through a single cable, the method comprising the steps of:
transforming the keyboard/mouse signals into keyboard/mouse data in a protocol standard;
switching to route the keyboard/mouse data in the protocol standard and the video data in the protocol standard;
transmitting the keyboard/mouse data and receiving the video data in the protocol standard to/from the selected computer through the single cable; and
transforming the video data in the protocol standard into video signals.

7. The method of claim 6, further comprising a step of transmitting the video signals to a display after the step of transforming the video data in the protocol standard into video signals.

8. The method of claim 7, further comprising a step of saving the video signals temporarily for buffering large transmission loading of the video signals before the step of transmitting the video signals to the display.

9. The method of claim 6, further comprising a step of determining whether the video signals are saved before the saving step.

10. The method of claim 6, wherein the protocol standard is Universal Serial Bus protocol standard.
